(19) United States
(12) Patent Application Publication
(10) Pub. No.: US 2019/0142674 A1
(43) Pub. Date: May 16, 2019

(54) HEALTHCARE BED SYSTEM

(71) Applicant: Jordan Guion, Emporia, KS (US)

(72) Inventor: Jordan Guion, Emporia, KS (US)

(21) Appl. No.: 15/810,054

(22) Filed: Nov. 11, 2017

(51) Int. Cl. A61G 9/00; A61G 7/02

(52) U.S. Cl. CPC A61G 9/003; A61G 7/047; A61G 7/02

(57) ABSTRACT

A health care bed system that includes: a bed; a mattress; a bed pan within the mattress; and a removal lid, where enables access to the bedpan. In one embodiment, the bedpan extracts from one side of the mattress. Alternatively, the bedpan extracts from a bottom side of the mattress and includes levers to lower the bedpan from the mattress.

### BACKGROUND OF THE INVENTION

### Field of Invention

The present invention relates to a healthcare bed that includes an integrated bedpan within the mattress.

### Description of Related Art

Healthcare beds are used in healthcare facilities to care for individuals during their restorative care. Healthcare beds are used in hospitals, nursing homes, and home healthcare beds are also available for some individuals. Most people who are bedridden usually need assistance in the maintenance of waste. Many times individuals have difficulty going to the bathroom and therefore may need assistance going to the bathroom or may be completely bedridden where they will require a bedpan in order to expel waste. Use of a bed pan can be a fairly laborious activity, which requires lifting and moving of the individual to use a bedpan and finally the cleaning associated with the process. As a result, it would be advantageous to have a bedpan that was integrated within the mattress. Such a bedpan could be used to assist in the removal of waste in a more efficient manner.

### SUMMARY OF THE INVENTION

The present invention relates to a health care bed system that includes: a bed; a mattress; a bed pan within the mattress; and a removal lid, where enables access to the bedpan. In one embodiment, the bedpan extracts from one side of the mattress. Alternatively, the bedpan extracts from a bottom side of the mattress and includes levers to lower the bedpan from the mattress.

### BRIEF DESCRIPTION OF DRAWINGS

FIG. 1 depicts a healthcare bed in accordance with the present invention.

FIG. 2 depicts an alternative embodiment of the healthcare bed in accordance with the present invention.

### DETAILED DESCRIPTION

The healthcare bed according to the present invention includes a bedpan that's integrated within the mattress. A lid is provided and is easily removed from the top surface of the mattress and allows access into the underlying bedpan. Two embodiments are provided with the present invention and described in detail below.

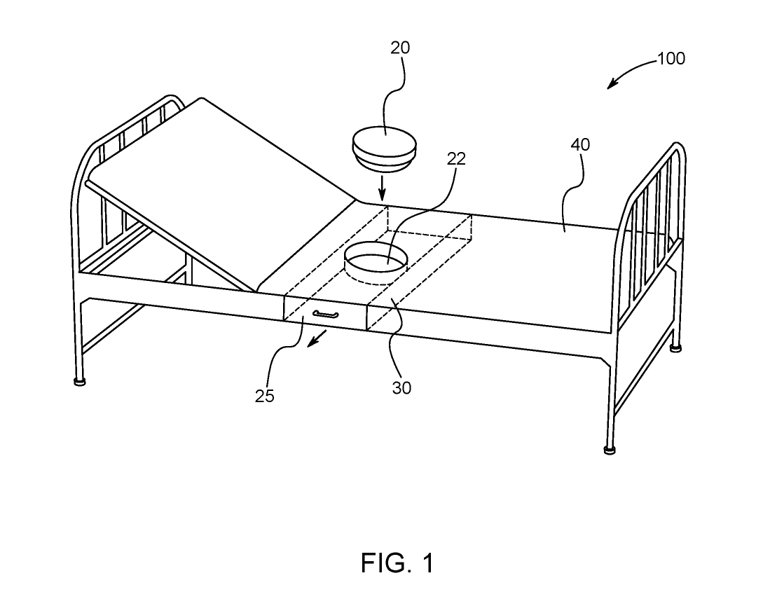

In reference to FIG. 1, a healthcare bed 100 is depicted. The healthcare bed 100 includes a mattress 40, which has an integrated bedpan 30. This bedpan 30 includes a lid 20 that is lifted and shown in FIG. 1. Opening 22 exposes for access to the interior of the Bedpan 30 that is integrated within the mattress 40. The bedpan 30 during use is open for patient use after completion, the lid 22 is placed back into place. The bedpan 30 is removed from one side of the mattress 40. A handle 25 is shown that extracts the bedpan from within the mattress. Once extracted the waste within the bedpan 30 may be deposed as needed.

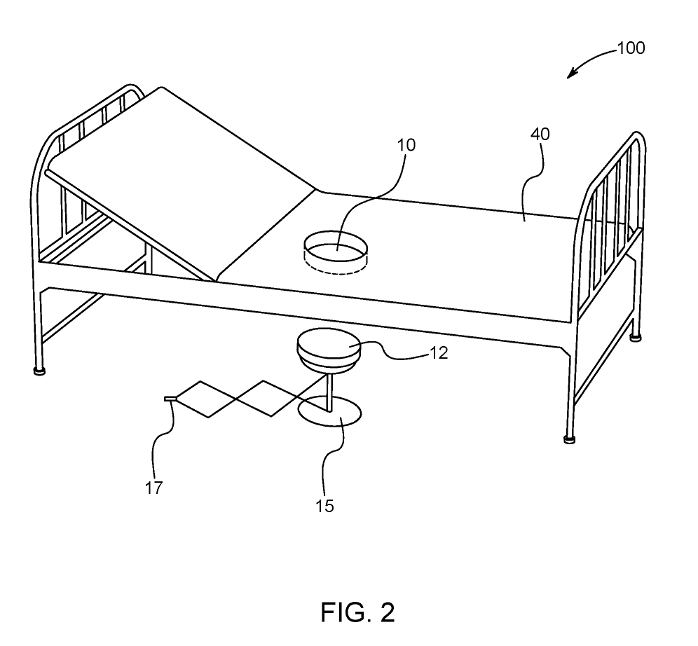

In reference to FIG. 2, a second embodiment of healthcare bed 100 is shown. The healthcare bed 100 includes a mattress 40, where a removal bedpan 12 is shown. This removal bedpan 12 inserts through an opening 10 in the mattress 40. Levers 17 are used to vertically remove the bedpan 12 into the opening 10. A base 15 is provided to support the bedpan 12 in a vertical position. The healthcare bed 100 according to the present invention therefore provides integrated bedpans that are easily removable and accessible by the patient. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A health care bed system comprising:
a bed;
a mattress;
a bed pan within the mattress; and
a removal lid, where enables access to the bedpan.

2. The health care bed system according to claim 1, where the bedpan extracts from one side of the mattress.

3. The health care bed system according to claim 1, where the bedpan extracts from a bottom side of the mattress.

4. The health care bed system according to claim 3, further including levers to lower the bedpan from the mattress.
